(19) United States
(12) Patent Application Publication
(10) Pub. No.: US 2022/0207445 A1
(43) Pub. Date: Jun. 30, 2022

(54) SYSTEMS AND METHODS FOR DYNAMIC RELATIONSHIP MANAGEMENT AND RESOURCE ALLOCATION

(71) Applicants: Suzanne Lea Sutton-Vermeulen, Ankeny, IA (US); Matthew Dominic Sutton-Vermeulen, Ankeny, IA (US); DMG Communication Co.

(72) Inventors: Suzi Sutton-Vermeulen, Ankeny, IA (US); Melissa Ehrenhard, Windsor Heights, IA (US)

(21) Appl. No.: 17/465,599

(22) Filed: Sep. 2, 2021

Related U.S. Application Data
(60) Provisional application No. 63/077,121, filed on Sep. 11, 2020.

(51) Int. Cl. G06Q 10/06

(52) U.S. Cl. CPC G06Q 10/0639

(57) ABSTRACT

Members of a team, including a first and second party, provide team assessments via user feedback associated with a performance of the team related to assessment criteria. Team scores are generated based on the user feedback. Discrepancies are determined based on the generated scores between the first and second party. A trained machine learning model generates team recommendations based on the feedback including the allocation or reallocation of computer resources.

### CROSS-REFERENCE TO RELATED APPLICATIONS

This application claims priority to U.S. Provisional Patent Application No. 63/077,121, filed Sep. 11, 2020, which is incorporated by reference herein in its entirety.

### FIELD OF THE DISCLOSURE

The present disclosure relates to the management of relationships between multiple parties, and, more particularly, to the aggregation and use of performance data associated with agency and client relationships.

### BACKGROUND

Current performance assessment systems are typically one-sided. For example, a typical assessment system assesses an individual's level of satisfaction with a certain entity. An example scenario would be a client expressing their level of satisfaction with an agent's performance. Typically, the client is presented with a survey to provide feedback along with a rating system to score the agent's performance. However, relationships between clients and agencies are not like other business partnerships. Such relationships are unique, more complex, emotional, and often subjective. Accordingly, simple one-way feedback is often insufficient to effectively measure and manage those relationships.

Accordingly, a system is needed that aggregates and utilizes assessment feedback data from multiple parties to improve an overall relationship between the parties through resource assessment and reallocation.

### BRIEF SUMMARY

The present embodiments may relate to, inter alia, systems and methods for the measurement and management of team assessment data to improve relationships between multiple parties. In some embodiments, the systems and methods described herein may include a web-based assessment tool to provide a holistic understanding that considers each side of a multi-faceted relationship. In one example embodiment, the process may be performed by a team analysis (TA) computing device.

In some embodiments, the systems and methods described herein facilitate assessing and managing relationships, such as agency and client relationships. Some embodiments may include the management of feedback received from multiple parties, such as client-side parties and agency-side parties.

In one aspect, a team analysis (TA) computing device for measuring and managing a relationship between at least two parties is disclosed. The TA computing device may include at least one processor in communication with at least one memory device. The at least one processor may be programmed to: (1) define a team, wherein the team includes a first party and a second party that each include at least one party member; (2) display, to at least one first party member and at least one second party member, via at least one user computing device, a team assessment form, wherein the team assessment form enables the at least one first party member and the at least one second party member to input user feedback associated with a performance of the team related to assessment criteria; (3) receive, from the at least one user computing device, first party user feedback from the at least one first party member and second party user feedback from the at least one second party member; (4) determine a first party team score based on the first party user feedback, wherein the first party team score is associated with the assessment criteria; (5) determine a second party team score based on the second party user feedback, wherein the second party team score is associated with the assessment criteria; (6) determine a combined team score based on the first party team score and the second party team score; (7) determine a discrepancy between at least two of i) the first party team score, ii) the second party team score, and iii) the combined team score; (8) utilize a trained machine learning model to generate a team recommendation based on the determined discrepancy, wherein the team recommendation includes an allocation or a reallocation of resources by at least one party member of the first and second parties; and (9) display the team recommendation, via the at least one computing device, to at least one of the at least one first party member and the at least one second party member. The computing device may include additional, less, or alternate actions, including those discussed elsewhere herein.

In another aspect, a computer-based method for tracking a relationship between two parties may be provided. The computer-based method may include steps of: (1) defining a team, wherein the team includes a first party and a second party that each include at least one party member; (2) displaying, to at least one first party member and at least one second party member, via at least one user computing device, a team assessment form, wherein the team assessment form enables the at least one first party member and the at least one second party member to input user feedback associated with a performance of the team related to assessment criteria; (3) receiving, from the at least one user computing device, first party user feedback from the at least one first party member and second party user feedback from the at least one second party member; (4) determining a first party team score based on the first party user feedback, wherein the first party team score is associated with the assessment criteria; (5) determining a second party team score based on the second party user feedback, wherein the second party team score is associated with the assessment criteria; (6) determining a combined team score based on the first party team score and the second party team score; (7) determining a discrepancy between at least two of i) the first party team score, ii) the second party team score, and iii) the combined team score; (8) utilizing a trained machine learning model to generate a team recommendation based on the determined discrepancy, wherein the team recommendation includes an allocation or a reallocation of resources by at least one party member of the first and second parties; and (9) displaying the team recommendation, via the at least one computing device, to at least one of the at least one first party member and the at least one second party member. The computer-based method may include additional, less, or alternate actions, including those discussed elsewhere herein.

In yet another aspect, at least one non-transitory computer-readable storage media having computer-executable instructions embodied thereon may be provided that, when executed by at least one processor, the computer-executable instructions cause the processor to: (1) define a team, wherein the team includes a first party and a second party that each include at least one party member; (2) display, to at least one first party member and at least one second party member, via at least one user computing device, a team assessment form, wherein the team assessment form enables the at least one first party member and the at least one second party member to input user feedback associated with a performance of the team related to assessment criteria; (3) receive, from the at least one user computing device, first party user feedback from the at least one first party member and second party user feedback from the at least one second party member; (4) determine a first party team score based on the first party user feedback, wherein the first party team score is associated with the assessment criteria; (5) determine a second party team score based on the second party user feedback, wherein the second party team score is associated with the assessment criteria; (6) determine a combined team score based on the first party team score and the second party team score; (7) determine a discrepancy between at least two of i) the first party team score, ii) the second party team score, and iii) the combined team score; (8) utilize a trained machine learning model to generate a team recommendation based on the determined discrepancy, wherein the team recommendation includes an allocation or a reallocation of resources by at least one party member of the first and second parties; and (9) display the team recommendation, via the at least one computing device, to at least one of the at least one first party member and the at least one second party member. The computer-executable instructions may include additional, less, or alternate actions, including those discussed elsewhere herein.

Advantages will become more apparent to those skilled in the art from the following description of the example embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown.

FIG. 1 depicts an example team analysis (TA) system in accordance with one or more embodiments of the present disclosure.

FIG. 2 depicts an example client computing device that may be used with the TA system illustrated in FIG. 1.

FIG. 3 depicts an example server system that may be used with the TA system illustrated in FIG. 1.

FIG. 4 depicts an example method for measuring and managing a relationship between at least two parties using the TA system illustrated in FIG. 1.

FIG. 5 depicts an example process for improving a collaborative working relationship using the TA system illustrated in FIG. 1.

FIG. 6 depicts an example user interface that may be generated by the TA system illustrated in FIG. 1.

FIG. 7 depicts an example user interface that may be generated by the TA system illustrated in FIG. 1.

FIG. 8 depicts an example user interface that may be generated by the TA system illustrated in FIG. 1.

FIG. 9 depicts an example user interface that may be generated by the TA system illustrated in FIG. 1.

FIG. 10 depicts an example user interface that may be generated by the TA system illustrated in FIG. 1.

FIG. 11 depicts an example user interface that may be generated by the TA system illustrated in FIG. 1.

FIG. 12 depicts a diagram of an example computing device that may be found in the TA system of FIG. 1.

The Figures depict example embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for the measurement and management of relationships between multiple parties, such as between an agency and the agency's clients. In some embodiments, the systems and methods described herein may include a web-based assessment tool to provide a holistic understanding that takes into account each side of a multi-faceted relationship. In one example embodiment, the process may be performed by a team analysis (TA) computing device, server, or a combination thereof.

In some embodiments, the systems and methods described herein may additionally or alternatively include the collection, or aggregation, of feedback data from a plurality of entities on a team. For example, the plurality of entities on a team may form a two-party relationship, such as an agency-client relationship. Additional groups of co-workers or colleagues may be included. The relationship may include different numbers of members on each side, such as six team members on the agency side and five team members on the client side, for example. Collectively, the team members may all be working collaboratively on the same project. Additionally, a certain project may include one or more sub-projects that may include a subset of team members on either side of the relationship.

In the example embodiment, the TA computing device is configured to aggregate feedback from multiple parties within a team in order to provide insight into the relationship between the parties and/or within each party. Specifically, the TA computing device is configured to define a team, parties within the team, and roles within each party, define and/or select assessment criteria, generate a team assessment form, display the team assessment form to the members of each party via a user interface, receive user feedback data via the user interface, aggregate the user feedback data and generate a team assessment including at least one of a combined team score and a party-specific score, generate and display an assessment visualization based on the team assessment, generate team recommendations based on the team assessment, and generate a report which includes at least one of the team assessment, assessment visualization, and team recommendations. The functionality of the TA computing device may be implemented, for example, using a custom software application and/or computer-implemented survey tools.

In an example embodiment, the systems and methods described herein include the collection, aggregation, and analysis of user feedback received from multiple parties within a team in order to provide insight into the relationship between the parties and/or within each party. For example, an agency-client relationship may include two parties, the agency and the client, working on a project (or projects) as part of a single team. Each party may include multiple party members, such that the overall team includes a plurality of party members from the client party and a plurality of party members from the agency party. Each party (e.g., the agency and the client) may have different expectations and criteria for evaluating team performance. For example, one party may value or assess a criterion such as “honest communication” higher than a criterion of “delivers results”, whereas the other party may value or assess those criteria differently.

In the example embodiment, the TA computing device is configured to receive feedback from multiple parties within a team regarding the performance of the team as a whole and aggregate the feedback, such that team performance scores may be generated for each party and for the team as a whole. In other words, for a team including party A and party B, the TA computing device receives feedback from all members of party A and party B regarding the performance of the team as a whole across multiple criteria. The TA computing device aggregates the feedback from party A and generates a party A team score (e.g., how well party A thinks the team did), aggregates the feedback from party B and generates a party B team score (e.g., how well party B thinks the team did), and aggregates the feedback from the whole team and generates a combined party team score.

In the example embodiment, the TA computing device is configured to define a team. Specifically, the TA computing device is configured to define a team, at least two parties within that team, and at least one party member within each party. In some embodiments, the team includes multiple parties that are working together on a single project, while in other embodiments, the team is working together on multiple projects or tasks over an extended period of time. Each party within the team represents a group, an organization, and/or an individual that is distinct from the other parties in some way. For example, parties may include groups and/or individuals from different business organizations (e.g., a client-agency relationship or a business partnership relationship), groups and/or individuals within a single business organization (e.g., two different departments), and groups and/or individuals associated in some other way. The TA computing device is further configured to assign a role to each party member, such as, but not limited to, “key decision-maker”, “primary contact”, or “contributor”. In some embodiments, the roles are merely descriptive, while in other embodiments the roles are used in assessing the team's performance (e.g., feedback from different roles may be weighted differently in the aggregation of feedback and calculation of an assessment score).

In the example embodiment, the TA computing device is further configured to generate an assessment form for the team. Specifically, the TA computing device is configured to receive user input for defining and/or selecting assessment criteria and generate an assessment form based on the assessment criteria. Assessment criteria may be any criteria for valuing or assessing team performance, and may include, but are not limited to, trust, strategy, creativity, expertise/specialization, planning, communication, collaboration, processes, conflict resolution, and team structure/roles, among others. In alternative embodiments, TA computing device presents predefined assessment criteria to a user, enables a user to define assessment criteria, or both. Based on the determined assessment criteria, the TA computing device is configured to generate a team assessment form, which the TA computing device may utilize for receiving user feedback regarding the assessment criteria.

In the example embodiment, the TA computing device is configured to receive user feedback from each party member through the team assessment form. The TA computing device may display the team assessment form through a user computing device (e.g., a client device or an agency device as described herein) and enable each party member to interface with the team assessment form in order to provide user feedback. The TA computing device receives the user feedback via each assessment form provided to each party member. In the example embodiment, user feedback is related to the assessment criteria, such that each team member provides user feedback scoring the team under each criteria. For example, the team assessment form may enable a user to rate the team's “trust”, “creativity”, and “communication” on a scale of 1 to 10. The TA computing device may collect user feedback via the team assessment form through text input boxes (e.g., through which users enter a numerical score or a qualitative description of team performance), slider bars, multiple choice selections, drop-down menus, or any other means for receiving user feedback. In some embodiments, the TA computing device is configured to transform any qualitative inputs into a numeric value.

In the example embodiment, the TA computing device is further configured to aggregate the user feedback and generate a team assessment score for at least one of the overall team and at least one party. Specifically, the TA computing device receives the user feedback, aggregates the user feedback data, and calculates a score based on the aggregated data. In some embodiments, the calculated score is simply the aggregate of the user feedback (e.g., a sum of all the feedback scores for each assessment criteria). In some embodiments, the TA computing device is configured to calculate a team assessment score for each assessment criteria. In other embodiments, the TA computing device is configured to calculate an overall team assessment score taking into account multiple or all of the assessment criteria. For example, the TA computing device may determine a “trust” score of 8.5, a “creativity” score of 9.2, and a “communication” score of 8.6 based on user feedback for each criteria. The TA computing device may further determine an overall team score of 8.8 based on the scores from all the criteria.

In the example embodiment, the TA computing device may be configured to generate a team assessment score for at least one of the overall team and at least one of the parties. Specifically, the TA computing device may be configured to generate an overall team assessment score for each assessment criteria by aggregating all feedback received for a specific criterion from all party members on the team and calculating the overall team assessment score based on the aggregated data. The TA computing device may be further configured to generate a party-specific score for each assessment criteria by aggregating all feedback received for a specific criterion from the members of a particular party, and calculating a party-specific score based on the aggregated data. In one embodiment, the TA computing device may be configured, for each assessment criteria, to generate an overall team score and party-specific team score for each party on the team. For example, for a team including party A and party B, the TA computing device may receive feedback from all members of party A and party B regarding the performance of the team as a whole across multiple criteria. The TA computing device aggregates the feedback from party A and generates a party A team score (e.g., how well party A thinks the team did), aggregates the feedback from party B and generates a party B team score (e.g., how well party B thinks the team did), and aggregates the feedback from the whole team and generates a combined party team score. In the example embodiment, the TA computing device is configured to generate a team assessment which includes at least one of the generated team scores.

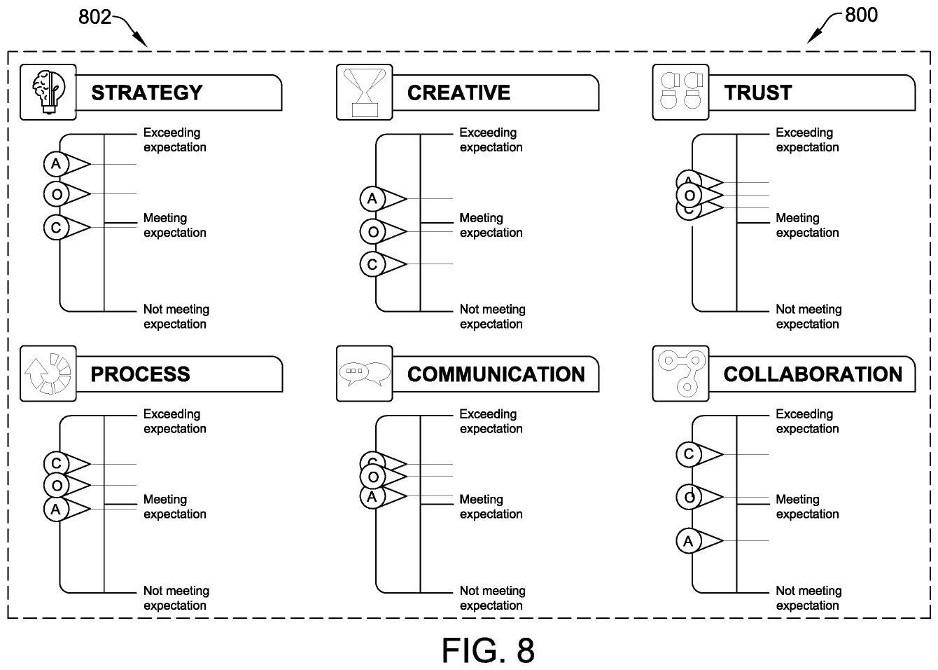

In the example embodiment, the TA computing device may be further configured to generate an assessment visualization based on the team assessment. Specifically, based on the team scores within the team assessment, the TA computing device may be configured to generate visualizations that enable a user to readily understand and compare the different scores within the team assessment. The TA computing device is further configured to generate assessment visualizations for single assessment criteria or multiple assessment criteria. For example, the TA computing device may generate a scale that ranges from “Negative” to “Positive”, and party specific scores and a combined team score may be represented on the scale with icons, such that the visualization enables a user to readily understand the relative standings of the scores. In one embodiment, the TA computing device generates a visualization that includes text and/or numbers indicating quantitative and/or qualitative aspects of the score. In another embodiment, the TA computing device generates visualizations such as graphs (e.g., bar graphs, line graphs, slider bars, pie charts, tag clouds) along with indicators for team scores displayed in the graph. In alternative embodiments, the TA computing device is configured to use color coding to illustrate high and low scores, as well as differentiate the icons associated with each score (e.g., different color icons representing party specific scores and a combined team score). Additional types of assessment visualizations are described in more detail with reference to FIGS. 8-11 below.

In the example embodiment, the TA computing device is configured to generate a team recommendation based on the team assessment and/or data visualizations. Specifically, the TA computing device is configured to analyze user feedback, both qualitative and quantitative, the team assessment, including both party specific and combined team scores, and determine recommendations (e.g., suggestions) for improving relationships within the team. In one embodiment, the TA computing device is configured to recognize large discrepancies between two party specific scores for a certain assessment criteria, and indicate to the party members of both parties that a discrepancy exists and that the expectations for the assessment criteria should be discussed. In another embodiment, the TA computing device is configured to recognize large discrepancies between the scores provided by party members within a party or team members within the overall team, enabling the TA computing device to recommend a meeting to discuss expectations for the team and/or party. In another embodiment, the TA computing device is configured to analyze qualitative feedback (e.g., text provided by a user) to determine a sentiment or qualitative score associated with a team, party, project, or individual. In the example embodiment, the TA computing device is configured to utilize trained machine learning models (e.g., a natural language processing (“NLP”) model or any other supervised or unsupervised model) for generating team recommendations (described in more detail below).

In the example embodiment, the TA computing device is further configured to generate a team report that includes at least one of the team assessment, assessment visualization, and team recommendations. In one embodiment, the TA computing device generates the team report and automatically distributes the report to team members (e.g. via a user computing device or a web portal). In another embodiment, the TA computing device is configured to generate notifications, alerts, and/or calendar events associated with the team report and/or team recommendations and transmit the notifications, alerts, and/or calendar events to users. For example, one or more of the notifications, alerts, and/or calendar events may be automatically generated in response to a team report being distributed or created.

In some embodiments, the systems and methods may include one or more calculated values based at least in part on the aggregated feedback data. For example, various types of feedback may be received by the TA computing device which is then processed and analyzed by the TA computing device. Results of the analysis may be displayed on a display device, such as a computer screen, transmitted to one or more locations (e.g., database storage, other user devices, server devices, etc.). In some outputs, the analysis results may be provided to a network administration computing device associated with one or more members of a team (e.g., agency, client, etc.). In some embodiments, the analysis results may include one or more parameters to alter resource allocation. For example, allocated resources may be increased, decreased, or re-assigned. Resources may include, but are not limited to, memory resources, network resources, I/O devices, hardware resources, software resources, or the like. Allocated resources may be changed in accordance with one or more recommendations based on aggregated feedback received by the TA computing device to improve at least one relationship between multiple parties of a relationship, such as an agency-client relationship.

Systems and methods of the TA computing device may include the outputting of different variations of analysis results based on one or more datasets. The one or more datasets may include one or more sets of data related to feedback data received from multiple users via computing devices, such as a mobile communication device, a tablet PC, or the like. Output results of an analysis may include variable outputs of data. For example, data outputs may include a score for each party of a certain relationship. The score may be on a scale, such as a scale of 1-100, 1-5, or even a percentage, relative to a certain point. For example, a low score or percentage may indicate a sour working relationship and a high score may indicate a good working relationship. In some embodiments, a score may be calculated from each perspective of a relationship. Additionally, or alternatively, scores from both sides of a relationship may be combined to create an overall score of a relationship. Similarly to above, the combined score may be on a scale to indicate the health of a relationship.

Systems and methods of the TA computing device may include the generation of team recommendations to improve a relationship between multiple team members. Team members may be associated with different agencies working towards a common goal, such as a collaborative effort on an ongoing project. The recommendations may be generated to improve a working relationship and may be shown in combination with one or more of the above described scores. The provided recommendations may be based on aggregated feedback data, score data, or a combination thereof. Additionally, or alternatively, the provided recommendations may be based on one or more machine learning models. In some embodiments, feedback data, recommendations data, and score data results may be provided in one or more visualizations, such as slider bars, bar graphs, pie charts, heat maps, tag clouds, or the like. Additionally, or alternatively, the results may be shown in a comprehensive report that may compile the one or more score, the one or more recommendations, and the one or more feedback visualizations, among other reporting factors.

As described below, systems and methods described herein create relationship assessment reports to formulate one or more recommendations to provide helpful feedback. In some embodiments, the one or more recommendations may be provided to improve a relationship between multiple parties working together on a collaborative project, or the like. As used herein, “agency-client relationship” refers to any type of working relationship between multiple teams of persons working collaboratively on a project. Generally, only those who are actually contributing to a project are considered members of an agency-client relationship group of members. However, it is understood that others may be included, such as those with an overseer role.

In some embodiments, the systems and methods may be used to implement a relationship management and assessment platform. In a relationship management and assessment platform, an indicator may be provided to all, or some, members within a relationship to a calculated health of a relationship. In some embodiments, the calculated health may be provided as a score. Additionally, or alternatively, the platform may provide to all, or some, members within a relationship group one or more recommendations for improving the relationship among the members working on a certain project. In some embodiments, the one or more recommendations may be sent to decision makers, such as those in a supervisory role, a management position, or the like.

In some example embodiments, systems and methods may be provided for the building of a model to accurately predict and provide a series of recommendations based on relationship feedback received. In some embodiments, the model may be created using machine learning techniques. Additionally, or alternatively, the model may be created using artificial intelligence techniques. The model may be stored on a memory device or within a data storage solution. Even further, the model may be continuously updated over time. Initialization data may be provided by a human operator to create the model.

The TA computing device may provide a platform enabling the aggregation of feedback data from multiple parties, or users. Users may provide feedback via one or more mobile devices. In some embodiments, users may provide feedback via a customizable form including a series of questions, rating scales (e.g., radio buttons or sliders), and/or one or more text box fields. Additionally, or alternatively, users may provide feedback via a desktop computer or a tablet device. In some embodiments, feedback data may be provided via a user-customizable graphical interface. Data entered via a text may be subjected to string-searching or string-matching algorithms to identify frequently-used words and/or phrases.

In some embodiments, the TA computing device may aggregate feedback data received from or submitted by multiple users of a two-party relationship. It is understood that more than two parties, or groups of users, may be part of the relationship. Each group of users may input feedback data that is used to rate, score, criticize and/or characterize other groups of users. Any and all types of feedback data may be accepted during the assessment process. For example, negative feedback may be encouraged to determine certain weaknesses existing within the relationship. In some embodiments, a subset of team members may not be aware of dissatisfaction of another subset of team members. Based on the assessment process, the weaknesses may be identified and one or more recommendations may be suggested for improving the relationship between groups of team members. In some embodiments, the one or more recommendations may be made in view of a relationship improvement model. Additionally, or alternatively, positive feedback may be aggregated from team members to identify strengths within the relationship. The positive feedback may then be used to dynamically update the aforementioned model.

In some embodiments, the TA computing device may provide one or more individual online assessments for team members to review and provide an option for a team member to provide more information. For example, a team member may want to provide further elaboration to explain the assessment they provided with respect to any positive or negative feedback. In some embodiments, a team member may be shown their assessment in summary form relative to one or more criteria elements. A web-based form may be provided including one or more text boxes where a user may input a further explanation of their assessment. Additionally, or alternatively, the team member may indicate their personal impact and possible solutions to strengthen a relationship.

In some embodiments, the TA computing device may provide a dashboard for interacting with an assessment platform. The dashboard may include a series of fully customizable modules and/or interfaces. For example, a third party (e.g., an advisor, a consultant, etc.), may be called upon to assist in improving a relationship between multiple parties, such as between an agency and a client working collaboratively on a project. It is understood that other types of relationships may exist. Each side of the relationship may comprise of one or more members. The third party may be, for example, an impartial third party free from bias.

In some embodiments, the TA computing device may be enabled to provide a user-customizable tool for implementing an assessment platform. For example, a user, such as the impartial third party, may create a questionnaire including one or more questions tailored to the relationship. The one or more questions may include specific questions related to a certain collaborative project, one or more generic relationship questions, or a combination thereof. Feedback may then be analyzed and an assessment may then be produced along with a series of recommendations to improve the relationship. In some embodiments, the assessment may provide feedback for an entire team of users. For example, one team may include a combination of both parties from both sides, or multiple sides, of a working relationship.

In one example embodiment, a database server may be used in conjunction with a TA computing device. The TA computing device and database server may work in the background as a facilitator to work with all parties of a relationship, such as a working relationship. For example, the parties may include an agency team and a client team having twelve people total and six per side. The group of team members may work collaboratively on an ongoing basis (e.g., daily, weekly, etc.) and become more like co-workers. In some embodiments, each of the members may be given different roles, such as decision-maker, everyday contributor, account executive, or the like. Additionally, or alternatively, each of the members may be actual contributors instead of mere observers of a team. Further, each team member may have one or more identified roles and may be given opportunities to provide feedback data.

In some embodiments, the TA computing device may process and analyze feedback data grading the overall effectiveness of a team. Certain categories may be established in view of project goals and the journey to achieve these goals. For example, the TA computing device may analyze what the team is actually producing and what type of strategy is being used. This data may then be aggregated with the feedback data provided, thereby providing insight as to why certain scores may be given by certain team members.

In one embodiment, the TA computing device may be configured to generate a team score visualization. The visualization may be based on one or more generated scores based on aggregated feedback. The visualization may be displayed via one or more output display devices or via one or more display modules. The TA computing device may be configured to generate the team score visualization based on aggregation and analysis of the team feedback and any scores generated for the parties associated with the feedback. For example, the TA computing device may receive team feedback from members of an agency party and members of a client party, and the TA computing device may aggregate the feedback from the members into an aggregate agency score and an aggregate client score. The TA computing device may then generate a team score visualization based on the aggregate agency and client scores, and display the visualization on a user computing device via a web page or an application, such as via a mobile device application. In alternative embodiments, the team score visualization may include, but is not limited to, numeric values for agency and client scores, scores represented via a graph or chart, such as a bar graph or a slider, or any other visual form that displays the scores to a user.

Systems and methods of the TA computing device may combine together an agency assessment and a client assessment to provide an overall assessment. Misalignment may be detected in at least one instance when a discrepancy in the assessment between each party exists. For example, an agency assessment may be rated poorly in a number of categories and a client assessment may be rated highly in the same corresponding categories, or vice versa. The TA computing device may then provide, as a facilitator, a series of recommendations to assist in bringing the agency and client to an agreed upon state with respect to expectations. In some embodiments, the series of recommendations may include solutions such as the shifting of personnel, the attainment of better technology, or even the allocation or reallocation, of network resources, or the like.

At least one of the technical problems addressed by this system may include (i) improper or ineffective understanding and handling of large data sets, (ii) improper allocation of computer resources between multiple users of a team, (iii) improper inclusion of ineffective team members or manpower, (iv) improper allocation of network resources, and (v) inefficiency of a working relationship between multiple team members on at least one side of a relationship due to the inability for the multiple team members to meet certain expectations.

A technical effect of the systems and processes described herein may be achieved by performing at least one of the following steps: (i) aggregating, via one or more web forms, questionnaires, mobile device applications, or the like, one or more elements of feedback with respect to a working relationship between multiple parties, (ii) analyzing and cross-referencing one or more datasets generated based on the aggregated feedback data provided by one or more users, (iii) creating recommendations based on one or more models built based on historical datasets, and (iv) allocating, or re-allocating, one or more computer resources or network resources based on created recommendations, and further the shifting of personnel based on one or more of the recommendations, the recommendations created to improve a working relationship between multiple users of a team.

Tag Cloud

In some embodiments, the TA computing device may implement a tag cloud, or weighted list, to provide a visualization of frequently used words, or terms, within the feedback provided by members of a team. For example, the TA computing device may provide a visual representation of popular topics for display on a user's device screen. In some embodiments, more popular terms may be displayed larger or in a bold font relative to less popular terms. Even further, positive terms and negative terms may be shown in different colors. For example, positive terms may be shown in green and negative terms may be shown in red.

In some embodiments, the TA computing device may generate one or more tag clouds using machine learning models, artificial intelligence, or a combination thereof. In some embodiments, a tag cloud may visually highlight positive or negative feedback provided by one or more users as described herein. Certain feedback may be shown in different colors. For example, red text may indicate negative feedback and green text may indicate positive feedback. Additionally, or alternatively, another color may be provided to indicate neutral feedback, such as yellow text color. Other colors may be used. In another example, the feedback text of a tag cloud may be represented by different sizes with respect to frequency of use or the like. For example, if a certain word is used more frequently in feedback data in relation to other words used, the word may be larger in font size in comparison to the other words of a tag cloud, which may be shown, albeit smaller in size.

In some embodiments, one or more tag clouds may be generated using machine learning models. In combination with one or more machine learning models, natural language processing may determine color, font size, actual font, or the like for display within a visualization, such as the tag cloud. In some embodiments, a user may identify one or more key words and stop words (e.g., common words like “the” or “an”) that should not be shown in a tag cloud. In some embodiments, positive or negative scores may be assigned to different types of words in relation to their meaning. A model may be used to determine important words and ignore common words.

Recommendation Engine

Systems and methods of the TA computing device may further include one or more implementations of a recommendation engine. A recommendation engine may include, or reference, the model discussed herein. One or more recommendations may be associated with one or more solutions to previously identified problems, for example. In some embodiments, recommendations may be associated or cross-referenced with the one or more solutions in a database. Additionally, or alternatively, the recommendations may be associated with previously-identified problems brought to light during prior feedback aggregation experiences.

In some embodiments, the TA computing device may be configured to provide one or more recommendations based on feedback aggregated from one or more team members of a relationship, such as a client-agency relationship, and/or assessment scores associated with the parties of a relationship. One or more provided recommendations may be provided to improve a relationship. In some embodiments, the systems and methods for providing a recommendation may include a spread or a deviation in a particular area. For example, deviation in a particular area may include a subject matter or strategy versus analysis or trust, etc. Based on aggregated feedback, a series of recommendations may be provided along with a rationale. For example, a rationale may include historical results or past performance.

In some embodiments, the TA computing device may update the recommendation engine model dynamically, or over time, based on recommendations provided to improve a relationship and subsequent feedback received after the provided recommendations have been implemented. Over time, the TA computing device may learn which suggested recommendations have actually been helpful and which have not been helpful in improving a relationship. Helpfulness ratings may be determined from further feedback received from members of a relationship, selective polling of one or more members of the relationship, or a combination thereof. Additionally, the model may be updated dynamically using machine learning techniques, artificial intelligence, or a combination thereof. For example, machine learning and/or AI may utilize intelligent analysis for making one or more recommendations. Machine learning and/or AI may perform semantic review of aggregated feedback by identifying keywords and performing further analysis on the identified keywords.

Example Computing System for Managing Relationships

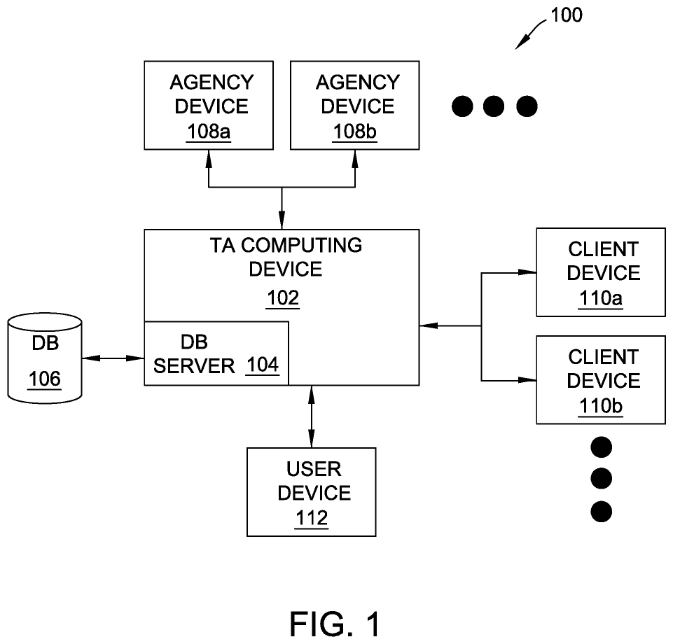

FIG. 1 depicts an example team analysis (TA) computing system 100. TA computing system 100 may include a TA computing device 102 (also referred to herein as a TA server or TA computing device). TA computing device 102 may include a database server 104. TA computing device 102 may be in communication with, for example, one or more of a database 106, one or more client devices 110a and 110b, a user computing device 112, and one or more agency devices 108a and 108b. Client devices 110a and 110b, user computing device 112, and agency devices 108a and 108b may be, for example, mobile computing devices, personal data devices, tablet computers, desktop or laptop computers, or the like. In some embodiments, TA computing device 102 may communicate with client devices 110a and 110b, user computing device 112, and agency devices 108a and 108b over a network, such as the Internet. In some embodiments, TA computing device 102 may communicate with additional devices substantially similar to devices 110a, 110b, 108a, 108b, and user device 112. In some embodiments, user device 112 may be associated with, for example, an entity for providing client/agency relationship management services between one or more agencies 108a and 108b and clients 110a and 110b. Additionally, or alternatively, clients 110 and agencies 108 may be part of a single team working collaboratively on a project.

In an example embodiment, client devices 110a or 110b may be computers that include a web browser or a software application, which enables user devices 108a or 108b to access remote computing devices, such as TA computing device 102, using the Internet or other network.

In some example embodiments, TA computing device 102 may aggregate feedback data from agency devices 108a and 108b as well as client devices 110a and 110b. Feedback data may be gathered from devices via a web-based form shown on a display of one or more of the respective devices. Based on a user of a device, such as a client or agency device, as well as their position (e.g., project manager, team member), different inquiries may be posed to the users to accurately collect the most relevant data being sought. Control of the TA computing device may be performed by user device 112 to select and/or tailor web forms or questionnaires distributed to agency and client devices 108 and 110, respectively.

In some embodiments, user device 112 may allow a user, such as an administrator, to perform settings operations of the TA computing device. Additionally, or alternatively, a user of user device 112 may facilitate the building of one or more models as described herein that may be used to generate one or more recommendations based on feedback data. Historical data models may be generated using machine learning, artificial intelligence, natural language processing, or a combination thereof. User device 112 may also be used to view the status of a relationship, such as a relationship between an agency composed of one or more users of agency devices 108 and client devices 110.

For example, once TA computing device 102 has aggregated feedback data from relationship participants of user devices 108 and 110, the feedback data sets may be compared to one or more historical data models stored on a database, such as database 106. Based on the feedback data, certain conclusions may be made by the TA computing device regarding the health of a relationship. For example, TA computing device 102 may calculate an overall score of a relationship as well as a score for each side of a multi-faceted relationship. Results may be propagated among all devices 112, 108, and 110.

In some embodiments, a data visualization may be generated by TA computing device 102 based on the aggregated feedback data from devices 108 and 110. The data visualization may include data gleaned from the feedback as well as calculated score data. The data visualization information may be provided to one or more devices 112, 108, and 110 and displayed on a screen associated with each of the devices. In some embodiments, the data visualization may be generated using one or more machine learning or natural language processing techniques.

The TA computing device 102 may determine one or more recommendations to improve a relationship between users of agency devices 108 and client devices 110 working together via a working relationship. In some embodiments, the one or more recommendations may be created in view of one or more historical data models retrieved from database 106. The one or more recommendations may be generated to improve a relationship through a plurality of different methods. Methods may include the shifting of personnel, such as the reassignment of certain team members to different projects, the allocation of computer or network resources, or the re-allocation of computer or network resources, for example. Other methods may be considered beyond those mentioned.

In some embodiments, TA computing device 102 may store historical feedback data on database 106. Control of database 106 may be facilitated via database server 104. Historical feedback data may be cross-referenced with one or more elements of recommendations data to build one or more models to predict future recommendations thereby providing data to improve a relationship, such as a working relationship between an agency and client working on a common goal or project.

In some embodiments, TA computing device 102 may continuously receive feedback from agency devices 108a and 108b and client devices 110a and 110b. Subsequent feedback may be processed and analyzed by TA computing device to continuously monitor and improve a relationship in view of historical data models retrieved from database 106. In some embodiments, the results of implemented recommendations may be tracked and used to update one or more historical data models.

In some embodiments TA computing device 102 may perform one or more processes to improve a relationship between multiple users using certain devices. The one or more processes may include and/or be communicatively coupled to one or more modules for implementing the systems and methods described herein. For example, in one example embodiment, a module may be provided for providing feedback of a plurality of users working collaboratively. For example, the plurality of users may include two groups of users providing feedback of each other. Feedback may be provided over a plurality of categories and may include scoring methodologies (i.e. rating scale of 1-5, etc.). Another module may analyze this feedback to generate an overall assessment. The overall assessment, in one embodiment, may reveal overall sentiment of the group as described herein. Another module may be provided to provide recommendations. Based on an overall assessment and a determined sentiment of the group, one or more recommendations may be formulated to improve relations between group members. For example, in some embodiments, certain strengths and weaknesses may be identified of team members within the collaborative group.

Example Client Computing Device

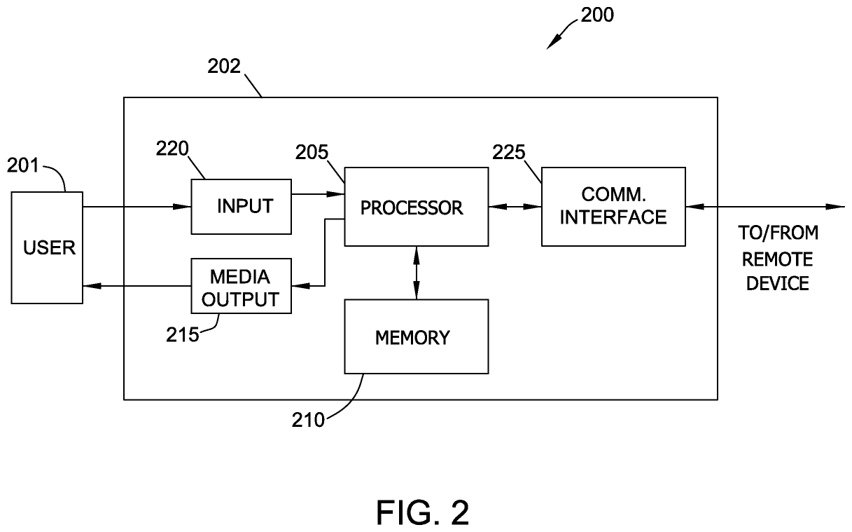

Block diagram 200 of FIG. 2 depicts an example client computing device 202 that may be used with the team analysis (TA) computing system shown in FIG. 1. Client computing device 202 may be, for example, at least one TA computing device 102, client computing device 110a or 110b, agency computing device 108a or 108b, or user computing device 112 (all shown in FIG. 1.

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In one or more example embodiments, computing device 202 may also include at least one media output component 215 for presenting information to a user, such as user 201. Media output component 215 may be any component capable of conveying information to user 201. In some embodiments, media output component 215 may include an output adapter such as a video adapter and/or an audio adapter. An output adapter may be operatively coupled to processor 205 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Media output component 215 may be configured to, for example, display a status of the model. In another embodiment, media output component 215 may be configured to, for example, display a result of an assessment along with a plurality of recommendations in response to receiving feedback data from a plurality of users.

Client computing device 202 may also include an input device 220 for receiving input from a user 201. Input device 220 may include, for example, a keyboard, a pointing device, a mouse, a stylus, a touch sensitive panel (e.g., a touch pad or a touch screen), or an audio input device. A single component, such as a touch screen, may function as both an output device of media output component 215 and an input device of input device 220.

Client computing device 202 may also include a communication interface 225, which can be communicatively coupled to a remote device, such as TA computing device 102 of FIG. 1. Communication interface 225 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 210 may be, for example, computer readable instructions for providing a user interface to user 201 via media output component 215 and, optionally, receiving and processing input from input device 220. A user interface may include, among other possibilities, a web browser or a client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are example only, and are thus not limiting as to the types of memory usable for storage of a computer program.

Example Server Computing Device

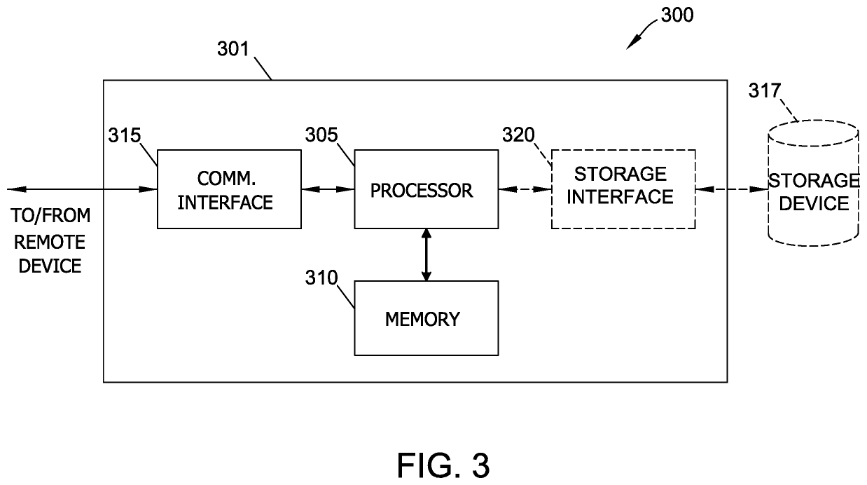

FIG. 3 depicts a block diagram 300 showing an example server system 301 that may be used with TA computing system 100 illustrated in FIG. 1. Server system 301 may be, for example, server computing device 104 (shown in FIG. 1).

In example embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with TA computing device 102, first client device 110a, second client device 110b, user device 112, agency device 108a, agency device 108b (all shown in FIG. 1), and/or another server system. For example, communication interface 315 may receive data from first client device 110a and/or second user device 110b via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317. In other embodiments, storage device 317 may be external to server system 301 and may be accessed by a plurality of server systems. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer system.

Example Method for Measuring and Managing a Relationship Between at Least Two Parties.

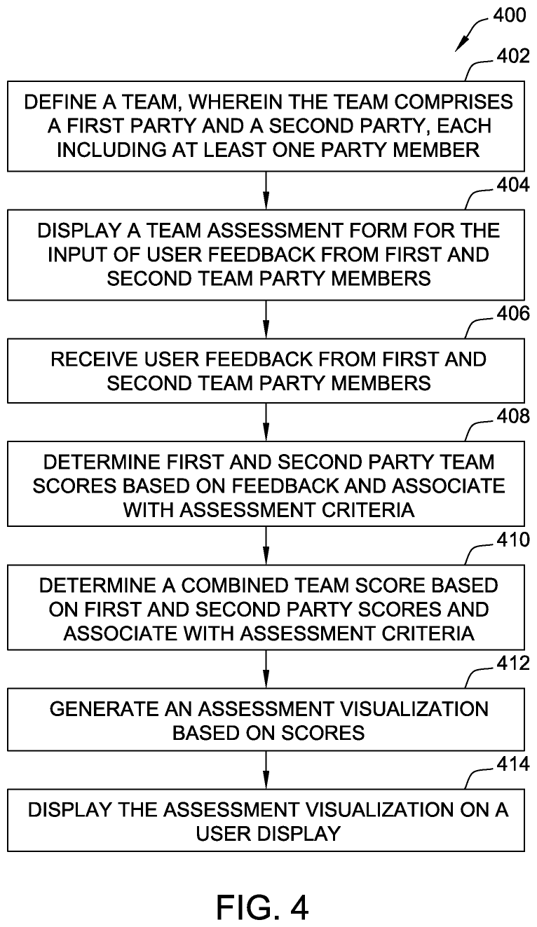

FIG. 4 depicts an example method 400 for measuring and managing a relationship between at least two parties. Method 400 may be implemented by TA computing device 102 illustrated in FIG. 1.

Method 400 may include defining 402 a team, wherein the team may include a first party and a second party. Each of the respective parties each include at least one team member. Team members may each be associated with a client computing device described herein. In some embodiments, each of the team members may be identified based on their role within the team including, but not limited to, supervisor, manager, contributor, collaborator, etc.

Method 400 may further include displaying 404 a team assessment form to team members from the first and second parties. For example, the team assessment form may be shown on a screen of a team member's device, such as a computer display or mobile device screen. The team assessment form may include one or more data input fields to enable a team member to provide feedback. Data input fields may be selected in accordance with one or more elements of assessment criteria.

Method 400 may further include receiving 406 user feedback from the first and second party members. User feedback may be provided via the one or more data input fields (e.g., radio buttons, sliders, text boxes, etc.). Once the form is complete, a user may submit the form, such as via a “submit” button or the like, to a receiving device, such as TA computing device 102 of FIG. 1. In some embodiments, the submitted forms may be transmitted to TA computing device 102 via a secure network connection and stored on a memory or within a database, such as database 106 of FIG. 1.

Method 400 may further include determining 408 scores for the first party of team members and the second party of team members. As described herein, scores may represent team members' sentiment of the team based on a plurality of elements of assessment criteria. In some embodiments, the scores may represent an overall health of the relationship between members of the team. Method 400 may further include determining 410 a combined team score based on the first and second party scores. The combined team score may be associated with the assessment criteria. In some embodiments, the assessment criteria may be pre-defined. The combined team score may provide a health indicator of the relationship between the two parties. For example, a higher score may indicate a good relationship while a lower score may indicate a dysfunctional relationship, as described herein.

Method 400 may further include generating 412 an assessment visualization based on the scores (e.g., first party score, second party score, and combined team score). The visualization may include a series of elements, such as a tag cloud highlighting common words detected amongst the feedback provided by the team members or other graphical elements, such as heat maps or comparison charts. In some embodiments, the method 400 may include displaying 414 the generated assessment visualizations on a user display, such as a display of user device 112 shown in FIG. 1. Other information may be displayed with the visualization, such as one or more recommendations to improve the relationship, historical data of past analysis showing the health of the team over time, as well as the effectiveness of implemented recommendations by the team, or the like.

Example Method for Performing a Team Assessment

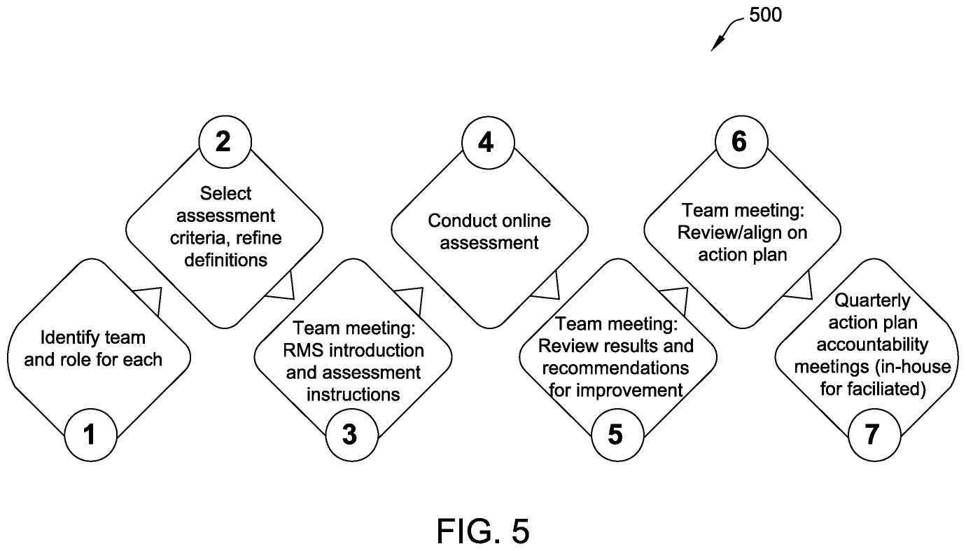

FIG. 5 depicts an example process for performing one or methods by the TA computing device and system. On one side of a relationship, multiple team members may be identified. Each team member may be assigned a role within the team. For example, roles may include key decision makers, primary contacts, contributors, or the like. Teams are not necessarily limited to these three types of roles. Key decision makers may have the authority to hire or terminate a relationship and have a functional role on the team. A primary contact role on the team may require a high percent of their time dedicated to the team and also have a high impact on the relationship and on the output. A team contributor may have a lower percentage of time dedicated to the team and therefore have a lower impact on the relationship and output. A contributor may have a functional role on the team.

Once a team and respective roles have been identified, an assessment may be selected based on certain criteria. Additionally, or alternatively, the selected assessment may include one or more refined definitions as part of the assessment. Assessment criteria may include, but is not limited to, trust, strategy, creativity, expertise/specialization, planning, communication, collaboration, processes, conflict resolution, and overall team structure and roles, for example. Other types of assessment criteria may be included. In some embodiments, a facilitator of the assessment may customize the assessment based on the identified team. The identified team may include members belonging to different companies or organizations. Once an assessment has been selected, a set of instructions may be generated for the members of the team with respect to the actual assessment. For example, the instructions of the assessment may be provided during a team meeting, during a video conference, a webcast, or the like. An assessment may then be conducted, for example, via an online application, such as via a desktop application or a mobile device application. As described herein, feedback data may be aggregated and analyzed to generate one or more recommendations to improve a relationship amongst the identified team members, such as a working relationship. The generated recommendations may then be distributed to one or more of the identified team members as part of an action plan to improve the relationship. In some embodiments, action plans may include the shifting of personnel, such as via re-assignment of roles within the team or to different teams, or the allocation of resources, such as computer or network resources. The assessment process may also include periodic re-assessments, such as weekly, monthly, quarterly, or even yearly assessment processes to promote constant improvement of the relationship.

Example Team Assessment Form

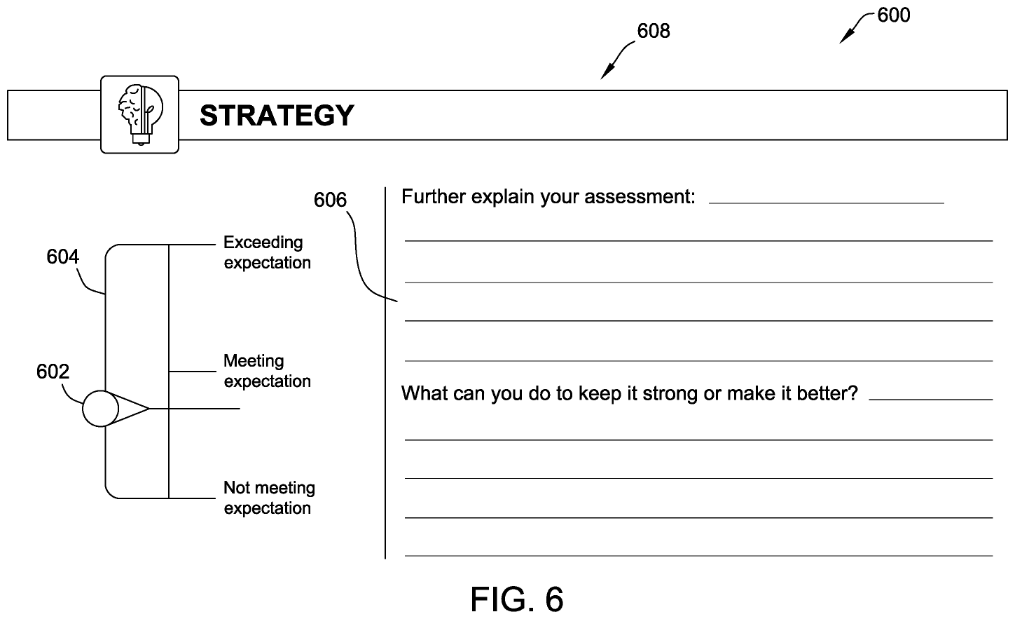

FIG. 6 depicts an example user interface 600 generated by TA computing device 102 (shown in FIG. 1) for receiving user feedback through team assessment form 608. User interface 600 enables a user to input user feedback for a given criteria, for example “Strategy”. In the example embodiment, the user utilizes slider bar 602 to give feedback on the team's overall “strategy” performance. The sliding scale may be labeled, color coded, or otherwise indicate the meaning of the user's input. For example, the top of the sliding scale may be labeled as “Exceeding expectations” and the bottom of the sliding scale may be labeled as “Not meeting expectations”, such that moving slider bar 602 closer to the top of the scale indicates the team is closer to exceeding expectations than not meeting expectations. In the example embodiment, TA computing device 102 is configured to determine a numerical value associated with the feedback provided via slider bar 602.

Example user interface 600 may further include text input 606 for enabling a user to provide user feedback in the form of text. Text inputs may enable a user to provide qualitative feedback, such as explaining a reason for a particular assessment or suggesting certain improvements. In one embodiment, TA computing device is configured to determine a numerical value associated with any qualitative feedback received from a user, such as by using natural language processing (“NLP”) to determine the meaning of the user feedback and determining a score for the feedback based on the positive or negative connotation.

Example Team Assessment

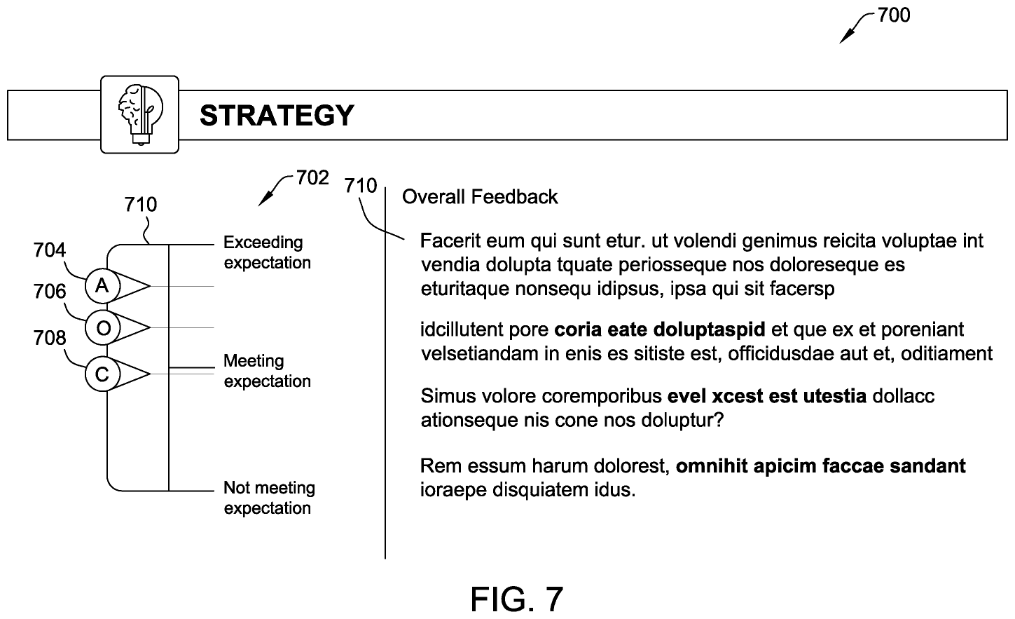

FIG. 7 depicts an example user interface 700 generated by TA computing device 102 (shown in FIG. 1) to display a team assessment to a user. User interface 700 includes team assessment visualization 702, which includes agency score 704, overall (e.g., “combined”) score 706, and client score 708. Agency score 704 and client score 708 are party specific scores based on user feedback received from party members of an agency party and a client party respectively. Overall score 706 is a combined team score based on feedback received from all party members of each party. Agency score 704, client score 708, and overall score 706 are positioned on slider bar 710 based on the value of the score. In one embodiment TA computing device 102 generates scores 704, 706, and 708 as numeric values based on user feedback and positions icons visualizing the scores based on the numeric values. For example, agency score 704 is positioned above overall score 706 and client score 708, indicating that party members of the agency party rated the overall team performance higher than the party members of the client party did, on average. In the example embodiment, user interface 700 further includes qualitative feedback 710, which may include text based on qualitative and/or text input received by TA computing device 102 through a team assessment form (such as team assessment form 608, shown in FIG. 6).

Example Team Assessment Report

FIGS. 8, 9, 10, and 11 depict user interfaces displaying embodiments of a team assessment report generated by TA computing device 102 (shown in FIG. 1).

FIG. 8 depicts a user interface 800 for displaying a plurality of team assessments 802 as part of a team assessment report. In the example embodiment, each of the plurality of team assessments 802 corresponds to a specific assessment criteria, such as “Strategy”, “Creative”, “Trust”, “Process”, “Communication”, and “Collaboration”, though additional or alternative criteria are depicted in alternative embodiments. Each of the plurality of team assessments 802 may be similar to assessment visualization 702 (shown in FIG. 7) and may include, in the example embodiment, a slider bar, an agency score, a client score, and an overall team score for each corresponding assessment criteria.

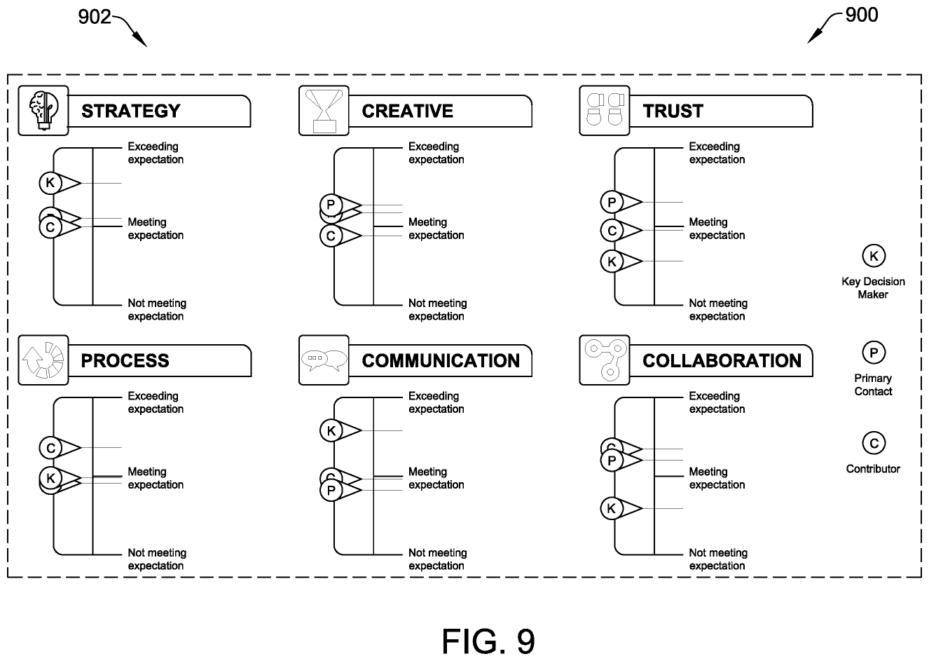

FIG. 9 depicts a user interface 900 for displaying a plurality of role-based team assessments 902 as part of a team assessment report. The plurality of role-based team assessments 902 may differ from the plurality of team assessments 802 in that the role-based team assessments 902 group team-scores by party member role as opposed to part. Specifically, TA computing device 102 aggregates feedback by party member role, such that team scores are generated for each role. In the example embodiment, scores based on the roles of “Key Decision-Maker”, “Primary Contact”, and “Contributor” are generated and visualized within the plurality of role-based team assessments 902.

In the example embodiment, each of the plurality of role-based team assessments 902 corresponds to a specific assessment criteria, such as “Strategy”, “Creative”, “Trust”, “Process”, “Communication”, and “Collaboration”, though additional or alternative criteria are depicted in alternative embodiments. Role-based team assessments 902 may include, in the example embodiment, a slider bar, a key decision-maker score, a primary contact score, and a contributor score for each corresponding assessment criteria.

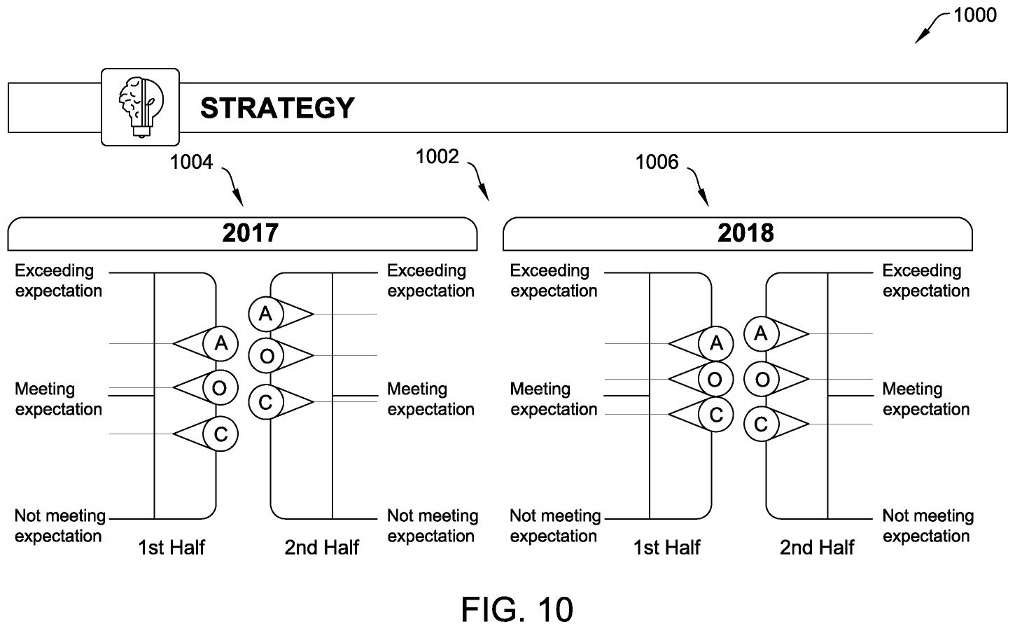

FIG. 10 depicts a user interface 1000 for displaying an analysis 1002 of team assessments over time. Analysis 1002 may include yearly team assessments 1004 and 1006, both of which are further divided into semi-annual assessments. Yearly team assessments 1004 and 1006 are associated with a particular assessment criteria (e.g., “Strategy”) and include a performance scale ranging from “Not meeting expectations” to “Exceeding expectations”, along with icons representing party specific and combined team scores. Yearly team assessments 1004 and 1006 may be similar to team assessment visualization 702 (shown in FIG. 7).

In the example embodiment, yearly team assessments 1004 and 1006 each include two assessment visualizations such that analysis 1002 depicts assessment visualizations for the 1^{st} half of 2017, the second half of 2017, the first half of 2018, and the second half of 2018. In this way, analysis 1002 depicts trends in party specific and combined team scores over time. For example, if the combined team score rises every half-year period, the team can be relatively confident that performance and/or understanding of the associated assessment criteria are improving over time.

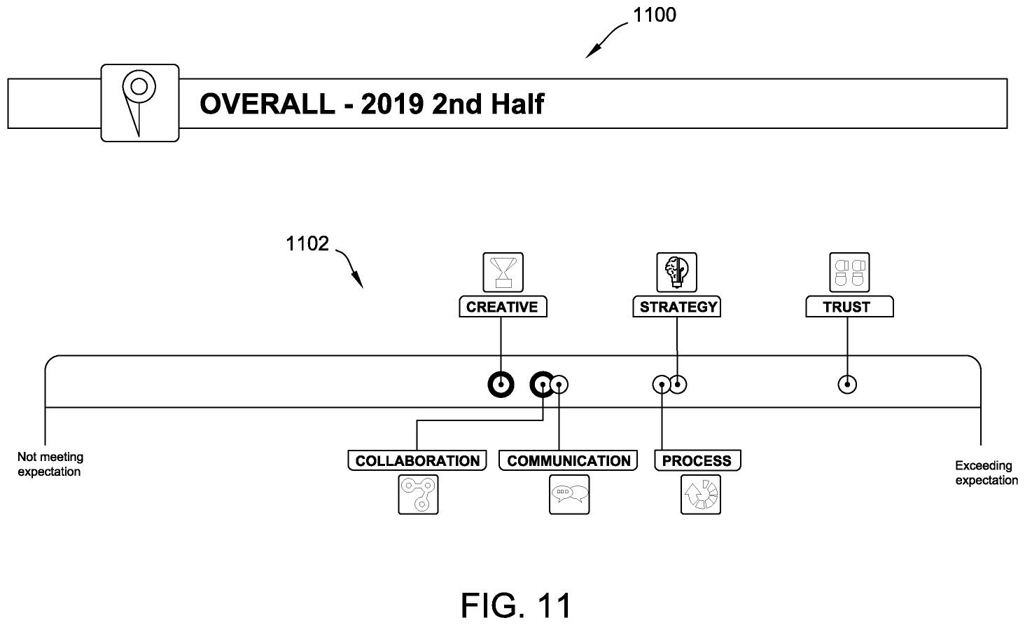

FIG. 11 depicts a user interface 1100 for displaying an analysis 1102 of combined team scores organized by criteria. In the example embodiment, analysis 1102 includes multiple combined team scores positioned within a continuum ranging from “Not meeting expectations” to “Exceeding expectations”. Each combined team score is associated with a particular assessment criteria, such that the combined team scores for multiple assessment criteria can be compared. For example, the combined team scores for “Creative”, “Collaboration”, “Communication”, “Process”, “Strategy”, and “Trust” may be displayed simultaneously along the continuum, such that a user can easily understand which assessment criteria are scored relatively higher or lower than the others.

Example Computing Device and Components

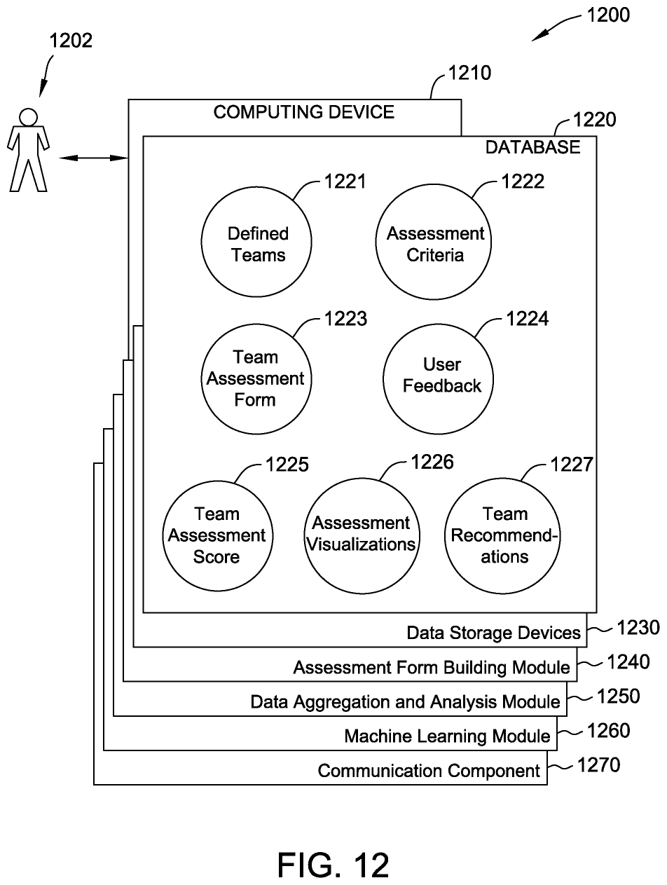

FIG. 12 depicts a diagram 1200 of components of one or more example computing devices 1210 that may be used in a team analysis system, such as team analysis (“TA”) computer system 100 (shown in FIG. 1). In some embodiments, computing device 1210 may be similar to TA computing device 102 (shown in FIG. 1). Database 1220 may be coupled with several separate components within computing device 1210, which perform specific tasks. In the present embodiment, database 1220 may store at least defined teams 1221, assessment criteria 1222, team assessment form 1223, user feedback 1224, team assessment score 1225, assessment visualizations 1226, and team recommendations 1227. In some embodiments, database 1220 is similar to database 106 (shown in FIG. 1).

Computing device 1210 may include database 1220, as well as data storage devices 1230, which may be used, for example, for storing data, such any of the data mentioned herein, locally. Computing device 1210 may also include assessment form building module 1240, data aggregation and analysis module 1250, machine learning module 1260, and communications component 1270, which may be utilized to implement the functionalities of a TA computing device as described herein.

Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, audio and/or video records, text, and/or actual true or false values. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

As described above, the systems and methods described herein may use machine learning, for example, for pattern recognition. That is, machine learning algorithms may be used by TA computing device 102, for example, to identify patterns between initial and subsequent feedback provided by entities, such as clients or agencies, and in view of recommendations made by the TA computing device 102. Accordingly, the systems and methods described herein may use machine learning algorithms for both pattern recognition and predictive modeling.

### Example Embodiments

In one aspect, a team analysis (TA) computing system for dynamically tracking a relationship between at least two parties may be provided. The TA computing system may include at least one processor in communication with at least one memory device. The at least one processor may be programmed to: (1) define a team, wherein the team includes a first party and a second party that each include at least one party member; (2) display, to at least one first party member and at least one second party member, via at least one user computing device, a team assessment form, wherein the team assessment form enables the at least one first party member and the at least one second party member to input user feedback associated with a performance of the team related to assessment criteria; (3) receive, from the at least one user computing device, first party user feedback from the at least one first party member and second party user feedback from the at least one second party member; (4) determine a first party team score based on the first party user feedback, wherein the first party team score is associated with the assessment criteria; (5) determine a second party team score based on the second party user feedback, wherein the second party team score is associated with the assessment criteria; (6) determine a combined team score based on the first party team score and the second party team score; (7) determine a discrepancy between at least two of i) the first party team score, ii) the second party team score, and iii) the combined team score; (8) utilize a trained machine learning model to generate a team recommendation based on the determined discrepancy, wherein the team recommendation includes an allocation or a reallocation of resources by at least one party member of the first and second parties; and (9) display the team recommendation, via the at least one computing device, to at least one of the at least one first party member and the at least one second party member.

Further, the computing device may include wherein the processor is further programmed to: generate an assessment visualization based on at least one of the first party team score, the second party team score, and the combined team score, wherein the assessment visualization is a visual representation of at least one of the scores, and display the assessment visualization, via the at least one computing device, to at least one of the at least one first party member and the at least one second party member.

The TA computer system may further include wherein the processor is further programmed to: generate a notification based on the team recommendation, and transmit the notification to the at least one user computing device such that the at least one user computing device displays the notification.

The TA computer system may further include wherein the processor is further programmed to: determine, using the trained machine learning model, that a meeting should be scheduled based on the determined discrepancy, automatically generate a calendar event for the meeting, and automatically transmit the calendar event to the at least one first party member and the at least one second party member.

The TA computer system may further include wherein the processor is further programmed to: generate an assessment report, wherein the assessment report includes at least one of the first party score, the second party score, and the combined team score in addition to at least one of the assessment visualization and the team recommendation, and display, via the at least one user computing device, the assessment report.

The TA computer system may further include wherein the processor is further programmed to: analyze, using a natural language processing model, the first party feedback and the second party feedback, determine, using the natural language processing model, at least one keyword included in at least one of the first party feedback and the second party feedback, and generate a tag cloud based on the determined at least one keyword.

The TA computer system may further include wherein the processor is further programmed to generate a team recommendation based on the determined at least one keyword.

In another aspect, a computer-based method for tracking a relationship between two parties may be provided. The method may be implemented by at least one computing device including the steps of: (1) defining a team, wherein the team includes a first party and a second party that each include at least one party member; (2) displaying, to at least one first party member and at least one second party member, via at least one user computing device, a team assessment form, wherein the team assessment form enables the at least one first party member and the at least one second party member to input user feedback associated with a performance of the team related to assessment criteria; (3) receiving, from the at least one user computing device, first party user feedback from the at least one first party member and second party user feedback from the at least one second party member; (4) determining a first party team score based on the first party user feedback, wherein the first party team score is associated with the assessment criteria; (5) determining a second party team score based on the second party user feedback, wherein the second party team score is associated with the assessment criteria; (6) determining a combined team score based on the first party team score and the second party team score; (7) determining a discrepancy between at least two of i) the first party team score, ii) the second party team score, and iii) the combined team score; (8) utilizing a trained machine learning model to generate a team recommendation based on the determined discrepancy, wherein the team recommendation includes an allocation or a reallocation of resources by at least one party member of the first and second parties; and (9) displaying the team recommendation, via the at least one computing device, to at least one of the at least one first party member and the at least one second party member.

The computer-based method may further include wherein the plurality of users include two or more subsets of users.

The computer-based method may further include wherein each of the two or more subsets of users comprise of at least one user.

The computer-based method may further include wherein the assessment includes a score indicating the health of the relationship.

The computer-based method may further include wherein the model is built using machine learning, artificial intelligence, or a combination thereof.

The computer-based method may further include wherein the feedback data is collected using a web-based form.

The computer-based method may further include wherein the one or more recommendations include improving the relationship by shifting personnel, upgrading technology, allocating network resources, reallocating network resources, or a combination thereof.

In yet another aspect, at least one non-transitory computer-readable media having computer-executable instructions embodied thereon may be provided. The instructions, when executed by a team analysis (TA) computing device including at least one processor in communication with a memory device may cause the at least one processor to: (1) define a team, wherein the team includes a first party and a second party that each include at least one party member; (2) display, to at least one first party member and at least one second party member, via at least one user computing device, a team assessment form, wherein the team assessment form enables the at least one first party member and the at least one second party member to input user feedback associated with a performance of the team related to assessment criteria; (3) receive, from the at least one user computing device, first party user feedback from the at least one first party member and second party user feedback from the at least one second party member; (4) determine a first party team score based on the first party user feedback, wherein the first party team score is associated with the assessment criteria; (5) determine a second party team score based on the second party user feedback, wherein the second party team score is associated with the assessment criteria; (6) determine a combined team score based on the first party team score and the second party team score; (7) determine a discrepancy between at least two of i) the first party team score, ii) the second party team score, and iii) the combined team score; (8) utilize a trained machine learning model to generate a team recommendation based on the determined discrepancy, wherein the team recommendation includes an allocation or a reallocation of resources by at least one party member of the first and second parties; and (9) display the team recommendation, via the at least one computing device, to at least one of the at least one first party member and the at least one second party member.

The media may further include wherein the plurality of users comprises of at least two teams, wherein each team comprises one or more users of the plurality of users.

The media may further include wherein the model is created using machine learning techniques, artificial intelligence, or both, and the model is built by relating historical feedback data, historical assessment data, and historical recommendation data.

The media may further include wherein the first party team score, the second party team score, and the combined team score are re-calculated in response to receiving subsequent feedback data from one or more team members.

The media may further include wherein the model is updated based at least in part on the re-calculated first party team score, second party team score, or combined team score.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

In some embodiments, registration of users for the TA system includes opt-in informed consent of users to data usage consistent with consumer protection laws and privacy regulations. In some embodiments, the collected data may be anonymized and/or aggregated prior to receipt such that no personally identifiable information (PII) is received. In other embodiments, the system may be configured to receive registration data and/or other collected data that is not yet anonymized and/or aggregated, and thus may be configured to anonymize and aggregate the data. In such embodiments, any PII received by the system is received and processed in an encrypted format, or is received with the consent of the individual with which the PII is associated. In situations in which the systems discussed herein collect personal information about individuals, or may make use of such personal information, the individuals may be provided with an opportunity to control whether such information is collected or to control whether and/or how such information is used. In addition, certain data may be processed in one or more ways before it is stored or used, so that personally identifiable information is removed.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A team analysis (TA) computing system for dynamically tracking a relationship between at least two parties, the TA computing system comprising at least one processor in communication with at least one memory device, wherein the at least one processor is programmed to:
define a team, wherein the team includes a first party and a second party that each include at least one party member;
display, to at least one first party member and at least one second party member, via at least one user computing device, a team assessment form, wherein the team assessment form prompts the at least one first party member and the at least one second party member to input user feedback associated with a performance of the team related to assessment criteria;
receive, from the at least one user computing device, first party user feedback from the at least one first party member and second party user feedback from the at least one second party member;
determine a first party team score based on the first party user feedback, wherein the first party team score is associated with the assessment criteria;
determine a second party team score based on the second party user feedback, wherein the second party team score is associated with the assessment criteria;
determine a combined team score based on the first party team score and the second party team score;
determine a discrepancy between at least two of i) the first party team score, ii) the second party team score, and iii) the combined team score;
utilize a trained machine learning model to generate a team recommendation based on the determined discrepancy, wherein the team recommendation includes an allocation or a reallocation of resources by at least one party member of the first and second parties; and
display the team recommendation, via the at least one computing device, to at least one of the at least one first party member and the at least one second party member.

2. The TA computer system of claim 1, wherein the processor is further programmed to:
generate an assessment visualization based on at least one of the first party team score, the second party team score, and the combined team score, wherein the assessment visualization is a visual representation of at least one of the scores; and
display the assessment visualization, via the at least one computing device, to at least one of the at least one first party member and the at least one second party member.

3. The TA computer system of claim 1, wherein the processor is further programmed to:
generate a notification based on the team recommendation; and
transmit the notification to the at least one user computing device such that the at least one user computing device displays the notification.

4. The TA computing system of claim 1, wherein the processor is further programmed to:
determine, using the trained machine learning model, that a meeting should be scheduled based on the determined discrepancy;
automatically generate a calendar event for the meeting; and
automatically transmit the calendar event to the at least one first party member and the at least one second party member.

5. The TA computing system of claim 1, wherein the processor is further programmed to:
generate an assessment report, wherein the assessment report includes at least one of the first party score, the second party score, and the combined team score in addition to at least one of the assessment visualization and the team recommendation; and
display, via the at least one user computing device, the assessment report.

6. The TA computing system of claim 1, wherein the processor is further programmed to:
analyze, using a natural language processing model, the first party feedback and the second party feedback;
determine, using the natural language processing model, at least one keyword included in at least one of the first party feedback and the second party feedback; and
generate a tag cloud based on the determined at least one keyword.

7. The TA computer system of claim 6, wherein the processor is further programmed to generate a team recommendation based on the determined at least one keyword.

8. A computer-based method for tracking a relationship between two parties, the method, with at least one computing device, comprising:
defining a team, wherein the team includes a first party and a second party that each include at least one party member;
displaying, to at least one first party member and at least one second party member, via at least one user computing device, a team assessment form, wherein the team assessment form prompts the at least one first party member and the at least one second party member to input user feedback associated with a performance of the team related to assessment criteria;
receiving, from the at least one user computing device, first party user feedback from the at least one first party member and second party user feedback from the at least one second party member;
determining a first party team score based on the first party user feedback, wherein the first party team score is associated with the assessment criteria;
determining a second party team score based on the second party user feedback, wherein the second party team score is associated with the assessment criteria;
determining a combined team score based on the first party team score and the second party team score;
determining a discrepancy between at least two of i) the first party team score, ii) the second party team score, and iii) the combined team score;
utilizing a trained machine learning model to generate a team recommendation based on the determined discrepancy, wherein the team recommendation includes an allocation or a reallocation of resources by at least one party member of the first and second parties; and
displaying the team recommendation, via the at least one computing device, to at least one of the at least one first party member and the at least one second party member.

9. The computer-based method of claim 8, further comprising:
updating the model based upon subsequent feedback data received after implementation of the provided one or more recommendations.

10. The computer-based method of claim 8, wherein the plurality of users include two or more subsets of users.

11. The computer-based method of claim 9, wherein each of the two or more subsets of users comprise of at least one user.

12. The computer-based method of claim 8, wherein the assessment includes a score indicating the health of the relationship.

13. The computer-based method of claim 8, wherein the model is built using machine learning, artificial intelligence, or a combination thereof.

14. The computer-based method of claim 8, wherein the feedback data is collected using a web-based form.

15. The computer-based method of claim 8, wherein the one or more recommendations include improving the relationship by shifting personnel, upgrading technology, allocating network resources, reallocating network resources, or a combination thereof.

16. At least one non-transitory computer-readable media having computer-executable instructions embodied thereon, wherein when executed by a team analysis (TA) computing device including at least one processor in communication with a memory device, the computer-executable instructions cause the at least one processor to:
define a team, wherein the team includes a first party and a second party that each include at least one party member;
display, to at least one first party member and at least one second party member, via at least one user computing device, a team assessment form, wherein the team assessment form prompts the at least one first party member and the at least one second party member to input user feedback associated with a performance of the team related to assessment criteria;
receive, from the at least one user computing device, first party user feedback from the at least one first party member and second party user feedback from the at least one second party member;
determine a first party team score based on the first party user feedback, wherein the first party team score is associated with the assessment criteria;
determine a second party team score based on the second party user feedback, wherein the second party team score is associated with the assessment criteria;
determine a combined team score based on the first party team score and the second party team score;
determine a discrepancy between at least two of i) the first party team score, ii) the second party team score, and iii) the combined team score;
utilize a trained machine learning model to generate a team recommendation based on the determined discrepancy, wherein the team recommendation includes an allocation or a reallocation of resources by at least one party member of the first and second parties; and
display the team recommendation, via the at least one computing device, to at least one of the at least one first party member and the at least one second party member.

17. The at least one non-transitory computer-readable media of claim 16, wherein the plurality of users comprises of at least two teams, wherein each team comprises one or more users of the plurality of users.

18. The at least one non-transitory computer-readable media of claim 17, wherein the model is created using machine learning techniques, artificial intelligence, or both, and the model is built by relating historical feedback data, historical assessment data, and historical recommendation data.

19. The at least one non-transitory computer-readable media of claim 18, wherein the first party team score, the second party team score, and the combined team score are re-calculated in response to receiving subsequent feedback data from one or more team members.

20. The at least one non-transitory computer-readable media of claim 19, wherein the model is updated based at least in part on the re-calculated first party team score, second party team score, or combined team score.
